(19) United States
(12) Patent Application Publication
(10) Pub. No.: US 2005/0213507 A1
(43) Pub. Date: Sep. 29, 2005

(54) Dynamically provisioning computer system resources

(75) Inventors: Dwip N. Banerjee, Austin, TX (US); Kavitha Vittal Murthy Baratakke, Austin, TX (US); Vasu Vallabhaneni, Austin, TX (US); Venkat Venkatsubra, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 10/809,591

(22) Filed: Mar. 25, 2004

(51) Int. Cl. H04L 12/26

(52) U.S. Cl. 370/241

(57) ABSTRACT

Methods, systems, and products are disclosed for dynamically provisioning server resources. More particularly, methods, systems, and products are disclosed for dynamically provisioning computer system resources that include monitoring a connection performance parameter of a data communications port operating in a data communications protocol having a connection backlog queue having a connection backlog queue size; and changing the connection backlog queue size in dependence upon the monitored connection performance parameter without interrupting the operation of the data communications port and without user intervention. In typical embodiments of the present invention, monitoring a connection performance parameter includes receiving a connection request and determining that the connection backlog queue is full, and changing the connection backlog queue size in dependence upon the monitored connection performance parameter includes increasing the connection backlog queue size.

### BACKGROUND OF THE INVENTION

1. Field of the Invention

The field of the invention is data processing, or, more specifically, methods, systems, and products for dynamically provisioning computer system resources.

2. Description of Related Art

Existing data communications environments have no way to dynamically provision computer resources to adapt to changes in current server load conditions. Connection-oriented data communications servers implement a listen or a connection backlog queue maximum size to administer data communications connections. The maximum size is usually a hard-coded limit. In AIX for example the maximum connection backlog queue size is 1024. Such maximum limits have no relationship to actual current server load. Connection-oriented ports may set a queue size at startup time smaller than such a system maximum, but the queue size cannot be changed without restarting the port. Once a queue subject to such a maximum is filled with connection requests, subsequent connection requests are dropped when they arrive, resulting in retransmissions from clients requesting connections. Most client systems will wait a period of time on the order of seconds before retransmitting a connection request, causing delays perceptible to users. In addition, such retransmissions add to network congestion and contribute to server overloading.

An alternative to limiting the maximum backlog queue size on a connection is to have a tunable maximum. A tunable maximum still suffers from disadvantages. A tunable maximum connection backlog queue size backlog is a system-wide limit enforced on all ports in a system. If such a parameter is set to a large value, system resources may be exhausted as the number of network services provided on the system grows. Although a port's initial backlog queue size can be initially set based on system resources, it cannot dynamically adapt to changing server load conditions. For example, in case the system is lightly loaded, and resources easily available, a specific port may not be able to handle incoming connections because the maximum backlog size limits the queue size. On the other hand, the system may be heavily loaded in which case a large constant backlog value may cause the system to exhaust its resources.

### SUMMARY OF THE INVENTION

Methods, systems, and products are disclosed for dynamically provisioning server resources based on current data communications load conditions and other monitored connection performance parameters so that servers can dynamically change connection backlog queue size without interfering with port operations and without human intervention. More particularly, methods, systems, and products are disclosed for dynamically provisioning computer system resources that include monitoring a connection performance parameter of a data communications port operating in a data communications protocol having a connection backlog queue having a connection backlog queue size; and changing the connection backlog queue size in dependence upon the monitored connection performance parameter without interrupting the operation of the data communications port and without user intervention. In typical embodiments of the present invention, monitoring a connection performance parameter includes receiving a connection request and determining that the connection backlog queue is full, and changing the connection backlog queue size in dependence upon the monitored connection performance parameter includes increasing the connection backlog queue size.

In typical embodiments of the present invention, monitoring a connection performance parameter includes monitoring a connection backlog queue load, and changing the connection backlog queue size includes changing the backlog queue size in dependence upon the connection backlog queue load. In many embodiments, monitoring a connection performance parameter includes calculating an average round trip time for a portion of a connection handshake and calculating an average arrival interval between connection requests, and changing the connection backlog queue size includes increasing the connection backlog queue size if the average arrival interval is less than the average round trip time and decreasing the connection backlog queue size if the average arrival interval is greater than the average round trip time.

In typical embodiments of the present invention, monitoring a connection performance parameter includes calculating a bandwidth delay product for a connection backlog queue and comparing the bandwidth delay product with the queue size; and changing the connection backlog queue size includes changing the backlog queue size to at least the bandwidth delay product if the connection backlog queue size is less than the bandwidth delay product. In many embodiments of the present invention, monitoring a connection performance parameter includes measuring accept processing time, and changing the connection backlog queue size includes changing the backlog queue size in dependence upon accept processing time. In some embodiments, monitoring a connection performance parameter includes calculating an average accept processing time and calculating an average connection request arrival interval for a connection backlog queue, and changing the connection backlog queue size includes increasing the connection backlog queue size if the accept processing time is greater than the connection request arrival interval.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 depicts an architecture for a data processing system in which various embodiments of the present invention may be implemented.

FIG. 2 sets forth a block diagram of an exemplary protocol stack for data communications between two devices connected through a network.

FIG. 3 sets forth a block diagram of automated computing machinery in which computer system resources may be dynamically provisioned according to embodiments of the present invention.

FIG. 4 sets forth a flow chart illustrating an exemplary method for dynamically provisioning computer system resources.

FIG. 5 sets forth a flow chart illustrating a further exemplary method for dynamically provisioning computer system resources.

FIG. 6 sets forth a flow chart illustrating a still further exemplary method for dynamically provisioning computer system resources.

FIG. 7 sets forth a flow chart illustrating a still further exemplary method for dynamically provisioning computer system resources.

FIG. 8 sets forth a calling sequence diagram illustrating a TCP connection handshake to establish a connection between a client and a server.

FIG. 9 sets forth a flow chart illustrating another exemplary method for dynamically provisioning computer system resources.

FIG. 10 sets forth a flow chart illustrating a still further exemplary method for dynamically provisioning computer system resources.

### DETAILED DESCRIPTION OF EXEMPLARY EMBODIMENTS

### Introduction

The present invention is described to a large extent in this specification in terms of methods for dynamically provisioning computer system resources. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Dynamically Provisioning Computer System Resources

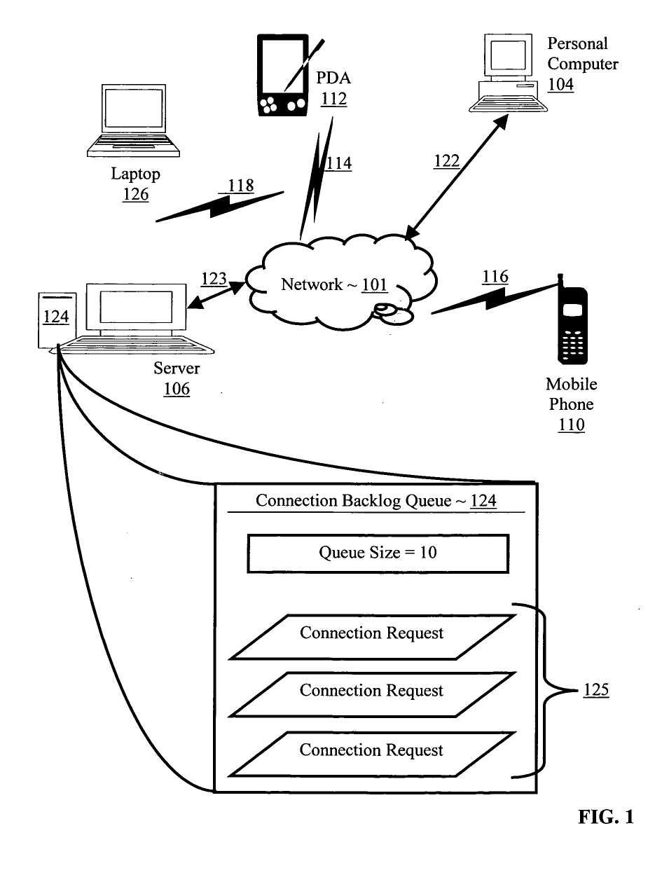

Exemplary methods, systems, and products for dynamically provisioning computer system resources are now explained with reference to the accompanying drawings, beginning with FIG. 1. FIG. 1 depicts an architecture for a data processing system in which various embodiments of the present invention may be implemented. The data processing system of FIG. 1 includes a number of computers connected for data communications through network (101). Network (101) may be any network for data communications, a local area network (“LAN”), a wide area network (“WAN”), an intranet, an internet, the Internet, a web, the World Wide Web itself, a Bluetooth microLAN, a wireless network, and so on, as will occur to those of skill in the art. Such networks are media that may be used to provide data communications connections between various devices and computers connected together within an overall data processing system.

In the example of FIG. 1, several exemplary devices including a PDA (112), a personal computer (104), a mobile phone (110), and a laptop computer (126) are connected to network (101). Network-enabled mobile phone (110) connects to network (101) through wireless link (116), and PDA (112) connects to network (101) through wireless link (114). In the example of FIG. 1, personal computer (104) connects through wireline connection (122) to network (101), and laptop (126) connects through wireless link (118). Server (106) connects through wireline connection (123).

The arrangement of servers and other devices making up the architecture illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, such as, for example, TCP/IP, HTTP, WAP, HDTP, and others as will occur to those of skill in the art. Various embodiments of the present invention may be implemented on a variety of hardware platforms in addition to those illustrated in FIG. 1.

Server (106) operates generally to dynamically provisioning computer system resources by monitoring a connection performance parameter of a data communications port operating in a data communications protocol having a connection backlog queue (124) having a connection backlog queue size. Server (106) receives connections requests from clients, and each connection request is acknowledged and then placed in a connection backlog queue until a connection is established between the server and the requesting client and accepted by an application on the server. In TCP, a connection request arrives in the form of a SYN message which is recorded as a socket in a SYN-RECD queue and moved to an ‘accept’ queue when a corresponding ACK is receiving from the requesting host. In this specification, the SYN-RECD queue and the ‘accept’ queue are referred to together as a connection backlog queue.

The connection queue size is the maximum number of connection requests that can be stored in the connection backlog queue. The connection backlog queue also has a load characteristic. The connection backlog queue load is the number of connection requests presently awaiting processing in the queue. In the example of FIG. 1, the connection backlog queue size is shown as 10 connection requests, and the connection backlog queue load is shown as three connection requests, leaving room for seven more requests in connection backlog queue (124). As described in more detail below, server (106) also operates to dynamically provisioning computer system resources by changing the connection backlog queue size in dependence upon a monitored connection performance parameter without interrupting the operation of the data communications port and without user intervention.

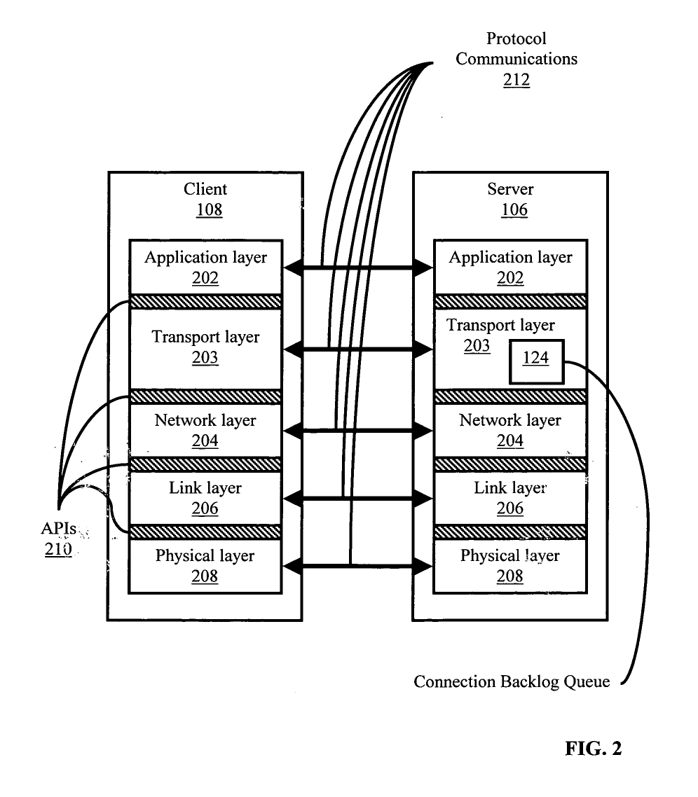

Data communications protocol operations are explained with reference to FIG. 2. FIG. 2 sets forth a block diagram of an exemplary protocol stack for data communications between two devices connected through a network. The exemplary protocol stack of FIG. 2 is based on the standard Open Systems Interconnection (“OSI”) Reference Model. The exemplary protocol stack of FIG. 2 includes several protocols stacked in layers. The exemplary protocol stack of FIG. 2 begins at the bottom with a physical layer (208) that delivers unstructured streams of bits across links between devices. Physical layer connections may be implemented as wireline connections through modems or wireless connections through wireless communications adapters, for example. The exemplary stack of FIG. 2 includes a link layer (206) that delivers a piece of information across a single link. The link layer organizes the physical layer's bits into packets and controls which device on a shared link gets each packet. The Ethernet protocol is an example of a link layer protocol. Ethernet addresses are 48 bit link layer addresses assigned uniquely to linked devices. A group of devices linked through a link layer protocol are often referred to as a LAN.

The stack of FIG. 2 includes a network layer (204) that computes paths across an interconnected mesh of links and packet switches and forwards packets over multiple links from source to destination. Packet switches operating in the network layer are typically referred to as “routers.” The stack of FIG. 2 includes a transport layer (203) that supports a reliable connection-oriented communication stream between a pair of devices across a network by putting sequence numbers in packets, holding packets at the destination until all arrive, and retransmitting lost packets. The stack of FIG. 2 also includes an application layer (202) where application programs reside that use the network. Examples of such application programs include web browsers and email clients on the client side and web servers and email servers on the server side.

Data communications (212) in such a stack model is viewed as occurring layer by layer between devices, in this example, between a client (108), upon which is installed a data communications application such as a browser or an email client that requests a data communications connection of server (106) in the transport layer. Data communication between the devices in the physical layer is viewed as occurring only in the physical layer, communication in the link layer is viewed as occurring horizontally between the devices only in the link layer, and so on.

Vertical communication among the protocols in the stack is viewed as occurring through application programming interfaces (“APIs”) (210) provided for that purpose. A browser, for example, operating as an application program in the application layer views its communications as coming and going directly to and from its counterpart web server on another device across the network. The browser effects its data communication by calls to a sockets API that in turn may operate a transmission control protocol (“TCP”) client, for example, in the transport layer. The TCP client breaks a message into packets, gives each packet a transport layer header that includes a sequence number, and sends each packet to its counterpart on another device through an API call to the network layer. The network layer may implement, for example, the well known Internet Protocol (“IP”) which give each packet an IP header and selects a communication route through the network for each packet, and transmits each packet to its counterpart on another device by calling down through its link layer API, typically implemented as a driver API for a data communication card such as a network interface card or “NIC.” When receiving data communication, the process is reversed. Each layer strips off its header and passes a received packet up through the protocol stack. Upward passes above the link layer typically require operating system context switches.

Most connection-oriented data communications is effected in the transport layer, typically by use of the Transmission Control Protocol or “TCP.” In addition, several examples in this specification are discussed in terms of TCP. It is useful to remember, however, that effecting data communications connections according to embodiments of the present invention are not limited in any way to TCP. Other protocols may be used to effect connections in the transport layer, and connection-oriented data communications can be carried out according to embodiments of the present invention in any data communication layer and in any data communications protocol that support connection-oriented communications.

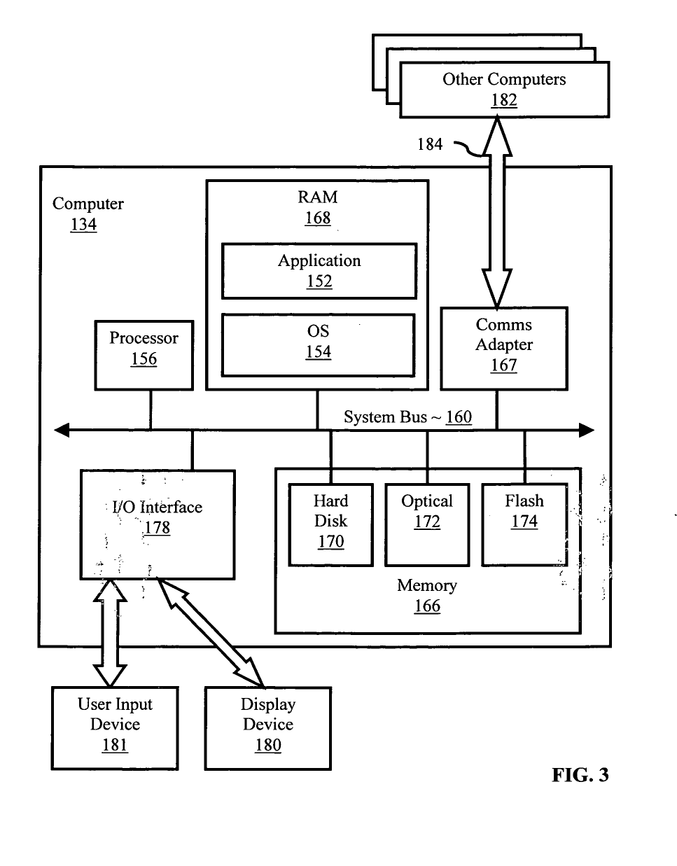

In the example of FIG. 2, a device that may request a connection is referred to as a ‘client’ and the device that may accept the request for a connection is referred to as a ‘server.’ In the example of FIG. 1, server (106) is depicted as a server and the other devices, the laptop (126), the PDA (112), the personal computer (104), and the mobile phone (110) are clients. In the usual terminology of TCP, devices are referred to as ‘hosts,’ clients are referred to as ‘foreign hosts,’ and servers are referred to as ‘local hosts.’ All such devices, however, are computers, automated computing machinery of some kind. For further explanation, FIG. 3 sets forth a block diagram of automated computing machinery comprising a computer (134) in which computer system resources may be dynamically provisioned according to embodiments of the present invention. The computer (134) of FIG. 3 includes at least one computer processor (156) or ‘CPU’ as well as random access memory (168) (“RAM”). Stored in RAM (168) is an application program (152). Application programs include in particular application programs that may request or accept data communications connections, including browsers, email clients, web servers, and email servers. Also stored in RAM (168) is an operating system (154). Operating systems useful in computers according to embodiments of the present invention include Unix, Linux, Microsoft NT™, and many others as will occur to those of skill in the art. TCP and other connection-oriented data communications clients and services are typically supported in an operating system. In particular, the functional steps of the present invention are typically carried out through computer program instructions implemented primarily within an operating system.

The computer (134) of FIG. 3 includes computer memory (166) coupled through a system bus (160) to processor (156) and to other components of the computer.

Computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer (134) of FIG. 3 includes a communications adapter (167) for implementing connections for data communications (184), including connection through networks, to other computers (182), hosts, servers, and clients. Communications adapters implement the hardware level of connections for data communications through which local devices and remote devices or servers send data communications directly to one another and through networks. Examples of communications adapters include modems for wired dial-up connections, Ethernet (IEEE 802.3) adapters for wired LAN connections, and 802.11b adapters for wireless LAN connections.

The example computer of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

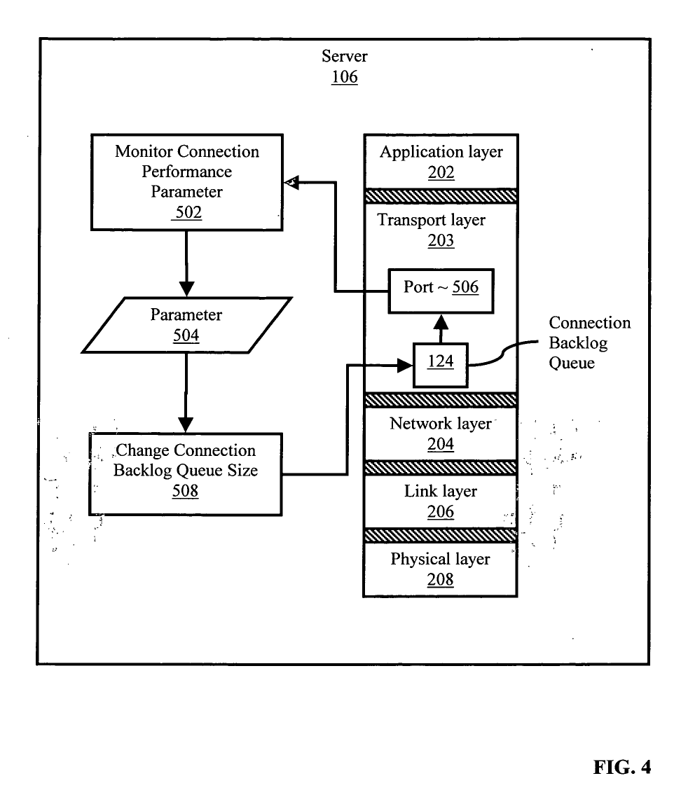

For further explanation, FIG. 4 sets forth a flow chart illustrating an exemplary method for dynamically provisioning computer system resources that includes monitoring (502) a connection performance parameter (504) of a data communications port (506) operating in a data communications protocol (203) having a connection backlog queue (124) having a connection backlog queue size. A connection performance parameter is any measure of system performance in establishing data communications connections. Examples of connection performance parameters include round trip time, bandwidth delay product, connection request arrival intervals (the inverse of request rate), accept processing time, and connection backlog queue load.

A data communications port is used by a data communications program that effects data communications with connections. Each port is assigned an identifying port number. Each server has an identifying network address. The combination of the port number and the network address uniquely identifies a data communications process anywhere in cyberspace. A port number in combination with a network address is the basic data complement of a socket. A socket having both the network address and port number of a client and a server is called a ‘connection.’ In the example of FIG. 4, the port operates in a transport layer, but that is for explanation, not for limitation. In fact, such a port may be operated in any protocol layer that supports connections for data communications.

The method of FIG. 4 also includes changing (508) the connection backlog queue size in dependence upon the monitored connection performance parameter (508) without interrupting the operation of the data communications port (506) and without user intervention. The ability to change the connection backlog queue size in dependence upon monitored connection performance parameters without interrupting the operation of the data communications port and without user intervention advantageously provides a mechanism for dynamic, on-demand provisioning of resources on a computer system. Although the system of FIG. 4 is shown with only one port, readers of skill in the art will realize that many such systems support many such ports. The method of FIG. 4 also provides the flexibility of using a per-port backlog size rather than enforcing a system-wide backlog size since some ports may be more heavily used than others. The server (106) can dynamically provision the resources, particularly computer memory, by increasing the backlog limit for this port on the fly, allowing it to gracefully manage overload conditions and reducing dropped connections, while keeping heed of system resources.

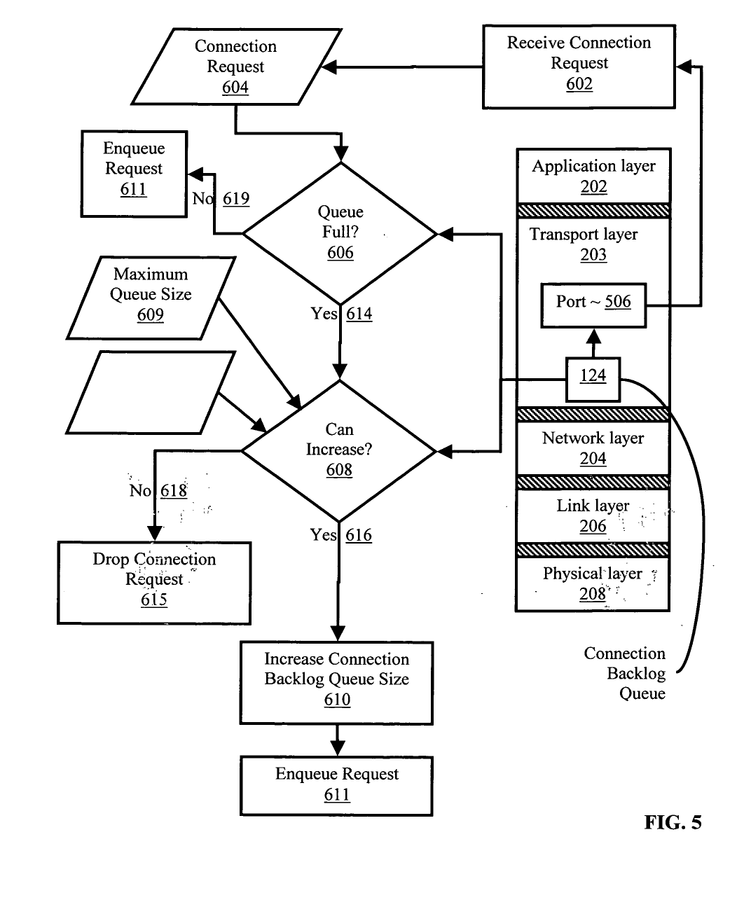

FIG. 5 sets forth a flow chart illustrating a further exemplary method for dynamically provisioning computer system resources in which monitoring a connection performance parameter includes receiving (602) a connection request (604) and determining (606) that the connection backlog queue (124) is full. If the connection request backlog queue is not full (619), the incoming connection request is placed on the connection backlog queue in the usual fashion. In TCP, as mentioned earlier, enqueueing a connection request is carried out by creating a socket and placing the socket in the connection backlog queue for a port.

In the method of FIG. 5, changing the connection backlog queue size in dependence upon the monitored connection performance parameter includes increasing (610) the connection backlog queue size. If the connection request backlog queue is full (614) processing continues with a determination (608) whether the connection request backlog queue size can be increased. The determination process (608) operates by comparing the current size of the connection backlog queue with a system parameter (609) defining the maximum queue size permitted on the system, and the determination process compares all the total size of all connection backlog queues for all ports operating on the system with a system parameter (612) defining the maximum memory allocation for connection request backlog queues.

If memory is available within the limit for all queues and the current size of the queue in question is smaller than the system maximum, then the process determines that it can (616) increase the size of the connection backlog queue and does so (610). The connection request is then enqueued (611) to await connection and acceptance. Note that in prior art, the connection request would have been dropped as soon as it was determined that the connection request backlog was full (614). In the method of FIG. 5, the connection request is dropped (615) only if it is determined (618) that it is not possible to increase the queue size in view of system limits.

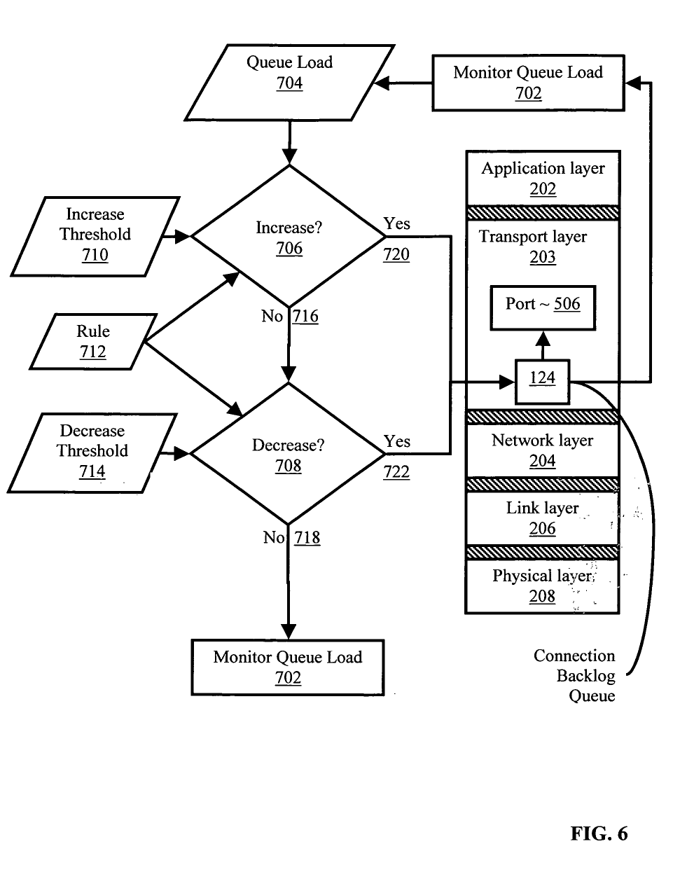

FIG. 6 sets forth a flow chart illustrating a still further exemplary method for dynamically provisioning computer system resources in which monitoring a connection performance parameter includes monitoring (702) a connection backlog queue load (704). Monitoring (702) a connection backlog queue load (704) may be carried out by having a process or thread periodically count the number of connection requests in the connection backlog queue. The count may be stored in a table with timestamps for the counts, thereby creating a load profile. Load averages and running averages may be calculated from the profile. The system may be configured with load thresholds (710, 714) for use in determining whether to increase or decrease connection backlog queue size. The system may be configured with rules (712) for determining how to increase or decrease connection backlog queue size according to load.

In the method of FIG. 6, changing the connection backlog queue size includes changing the backlog queue size in dependence upon the connection backlog queue load (704). In the method of FIG. 6, if a measure of queue load (704) is greater than an increase threshold (710), connection backlog queue size is increased (720). If a measure of queue load (704) is less than a decrease threshold (714), the connection backlog queue size is decreased (722). The method of FIG. 6 also may operate according to connection queue adjustment rules (712). An example of a connection queue adjustment rule is:
Rule 1: if queue size is more than 10% larger or smaller than an average load, change queue size to 125% of the average load

Consider an example in which a connection backlog queue has a queue size of 50 connection requests and a running average load of 48 connection requests. Such a queue occasionally fills and drops connections requests. Operating according to Rule 1 above, the method of FIG. 6 increases (720) the queue size to 60, thereby reducing the risk of a dropped connection requests. In an example with a queue size of 50 and a running average load of 10, the method of FIG. 6 operating according to Rule 1, decreases the queue size to 13, releasing memory for use by other processes, thereby improving efficiency of computer resource allocations.

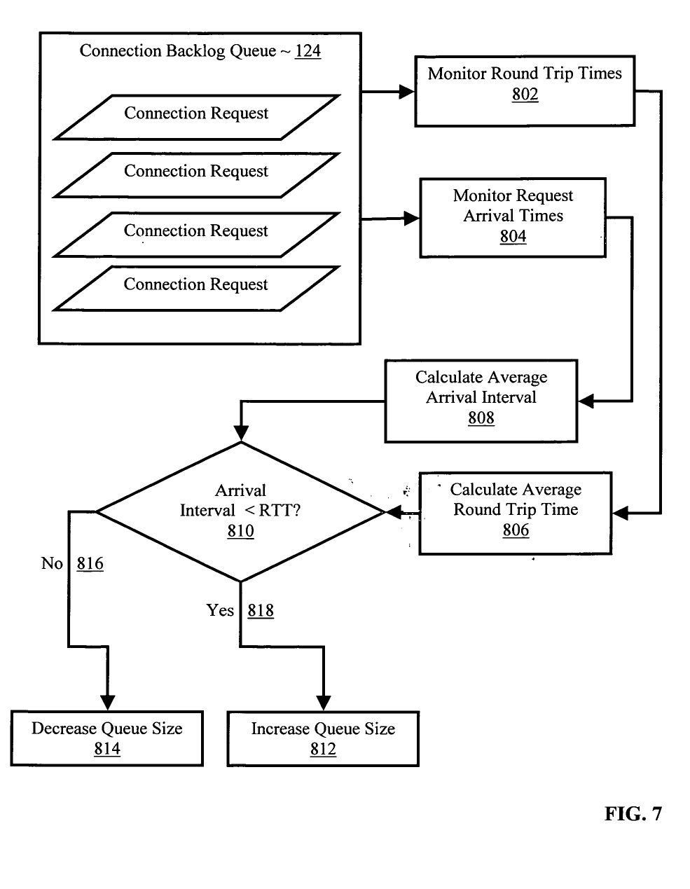

FIG. 7 sets forth a flow chart illustrating a still further exemplary method for dynamically provisioning computer system resources in which monitoring a connection performance parameter includes calculating (806) an average round trip time for a portion of a connection handshake and calculating (808) an average arrival interval between connection requests. In this example, calculating an average round trip time is carried out by monitoring (802) round trip times, measuring them and storing them in a profile from which a running average is calculated. In this example, calculating (808) an average arrival interval between connection requests is carried out by monitoring (804) request arrival times, storing them in a profile from which a running average is calculated. In the method of FIG. 7, changing the connection backlog queue size is carried out by increasing (812) the connection backlog queue size if the average arrival interval is less than the average round trip time and decreasing (814) the connection backlog queue size if the average arrival interval is greater than the average round trip time.

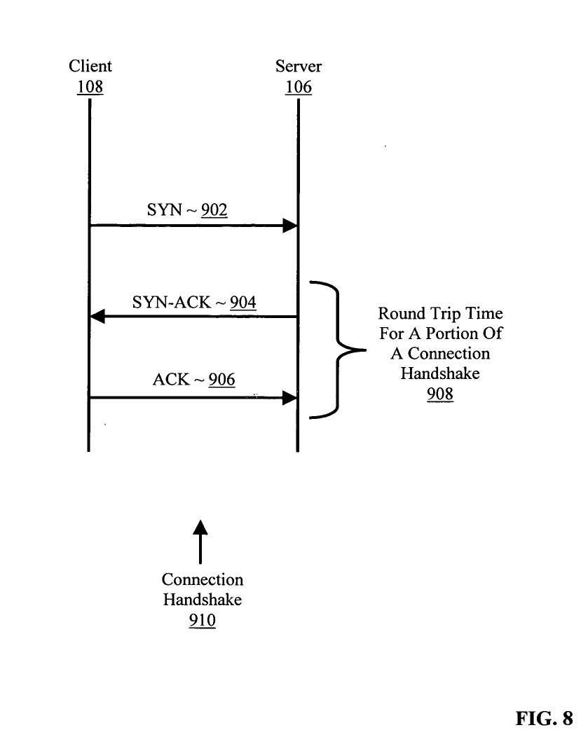

Round trip time is explained further with reference to FIG. 8. FIG. 8 sets forth a calling sequence diagram illustrating a TCP connection handshake (910) to establish a connection between a client (108) and a server (106). TCP is used for ease of explanation, but the use of TCP is not a limitation of the present invention. Any protocol that supports connection-oriented data communications may be used. In TCP, the connection request as received by the server (106) is a TCP SYN message (902), so-called because it is identified as a connection request by setting the SYN (‘synchronize’) flag in the TCP message header.

When it receives a SYN message, the TCP service in the server operating system transmits a SYN-ACK message (904) back to the client (108), the SYN flag in the message header representing a request to the client to proceed with establishing the connection and the ACK acknowledging receipt of the client's SYN (902). The TCP service on the server then creates a socket to hold the connection data, the network addresses and port numbers for the client and the server-side data communications application, and places the socket in the connection backlog queue. The socket waits in the connection backlog queue until a return ACK (906) is received from the client and the port on the server side accepts the connection.

The sequence of messages required to establish a connection is a ‘connection handshake.’ The SYN/SYN-ACK/ACK sequence of messages (902, 904, 906) is an example of a connection handshake (910). The time interval (908) between the TCP service's sending of the SYN-ACK (904) and the receipt of the client's ACK (906) is a round trip time for a portion of a connection handshake.

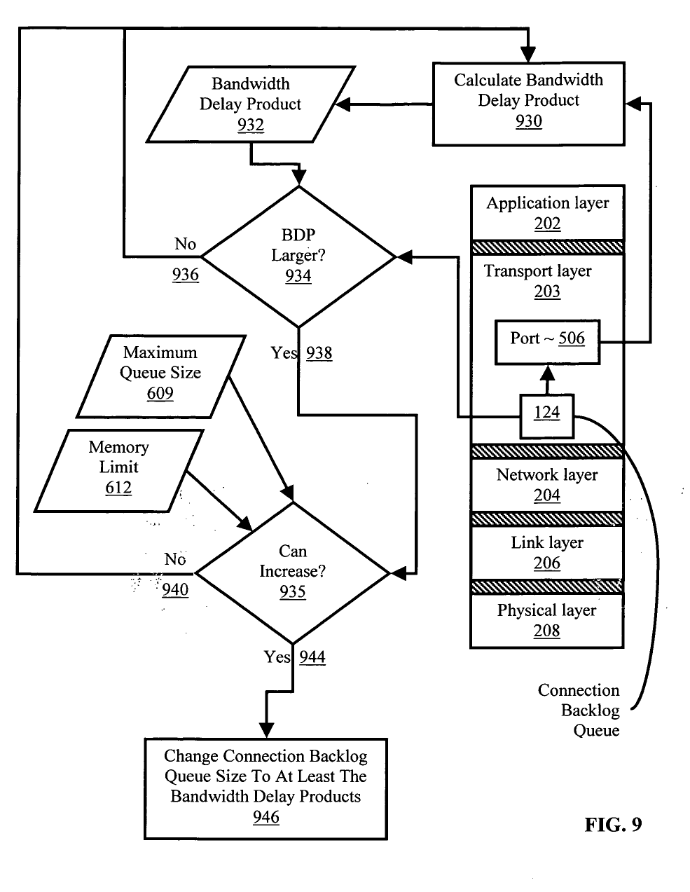

FIG. 9 sets forth a flow chart illustrating another exemplary method for dynamically provisioning computer system resources. In the method of FIG. 9 monitoring a connection performance parameter includes calculating (930) a bandwidth delay product (932) for a connection backlog queue (124) and comparing (934) the bandwidth delay product (932) with the queue size. The bandwidth portion of the bandwidth delay product is a measure of the data communications speed for the network data communications port. The bandwidth may be measured, calculated, or configured from a known network topology. In a network of know topology, for example, in which data communications is effected on a full rate T1 lines, the bandwidth is 1.544 Mbps or 193,000 bytes/second. The delay portion of the bandwidth delay product is taken as one-half the round trip time. In the exemplary network with the T1 lines, for a port whose connection backlog queue runs with an average round trip time of 100 milliseconds, the delay is 50 milliseconds, 0.05 seconds. For this connection queue, the bandwidth delay product is 193,000×0.05 bytes=9650 bytes. If the size of each data communications packet in the data communications protocol for the port is one kilobyte, then 10 connection requests can fit in the channel, and the connection backlog queue size needed to accommodate all the connection requests that can fit in the channel is 10. The size of the data structures representing connection requests in the connection backlog queue, of course, is unlikely to be the same as the size of the data communications packets.

In the method of FIG. 9, changing the connection backlog queue size includes changing (946) the backlog queue size to at least the bandwidth delay product (932) if the connection backlog queue size is less than the bandwidth delay product (938).

Changing (946) the backlog queue size to at least the bandwidth delay product (932) if the connection backlog queue size is less than the bandwidth delay product (938) advantageously reduces the risk of dropping connection requests because the connection backlog queue is large enough in principle to contain all the data that can fit in the data communications channel on which its port listens.

In the method of FIG. 9, if the connection backlog queue size is less than the bandwidth delay product (938), changing the connection backlog queue size in dependence upon a monitored connection performance parameter processing continues with a determination (935) whether the connection request backlog queue size can be increased. The determination process (935) operates by comparing the current size of the connection backlog queue with a system parameter (609) defining the maximum queue size permitted on the system, and the determination process compares the total size of all connection backlog queues for all ports operating on the system with a system parameter (612) defining the maximum memory allocation for connection request backlog queues. If memory is available within the limit for all queues and the current size of the queue in question is smaller than the system maximum, then the process determines that it can (944) increase the size of the connection backlog queue and does so (946).

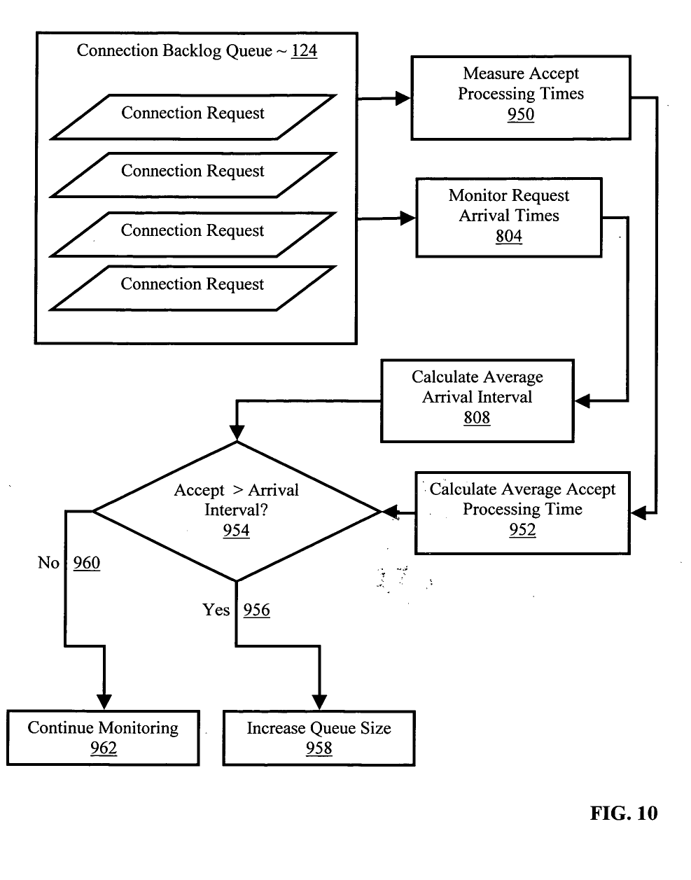

FIG. 10 sets forth a flow chart illustrating a still further exemplary method for dynamically provisioning computer system resources in which monitoring a connection performance parameter is carried out by measuring (950) accept processing time and monitoring (804) connection request arrival time. In the method of FIG. 10, changing the connection backlog queue size is carried out by changing (958) the backlog queue size in dependence upon accept processing time and connection request arrival times. More particularly in the method of FIG. 10, monitoring a connection performance parameter is carried out by calculating (952) an average accept processing time and calculating an average connection request arrival interval (808) for a connection backlog queue (124). In the method of FIG. 10, changing the connection backlog queue size includes increasing (958) the connection backlog queue size if the accept processing time is greater than the connection request arrival interval.

The connection request arrival interval is the inverse of the connection request rate, the rate at which connection request arrive and are placed in the connection backlog queue. The average load of the connection backlog queue depends on the average round trip time between the server and its clients and depends also upon the connection request rate—because a connection request stays on the queue for a period of time equal to the round trip delay plus the accept processing time. Long round-trip delays and high request rates increase the length of the connection backlog queue. The connection backlog queue load also depends on how fast a server process calls accept( ), that is, the rate at which it serves requests. If a server is operating at its maximum capacity, it cannot call accept( ) fast enough to keep up with the connection request rate and the queue load increases.

The following is a pseudocode example of an exemplary server process that opens a socket on a port and accepts connections from a connection backlog queue:

```
int listenSocket, connectSocket;
int QUEUE_SIZE = 5;
if ((listenSocket = socket( ... )) < 0 )
    err_sys(“socket error”);
if(bind(listenSocket, ... ) < 0 )
    err_sys(“bind error”);
if(listen(listenSocket, QUEUE_SIZE) < 0 )
    err_sys(“listen error”);
for (;;) {
    connectSocket = accept(connectSocket, ... ); /* blocks */
    if(connectSocket <0)
        err_sys(“accept error”);
    if(fork( ) == 0) {
        /*** child processing ***/
        close(listenSocket);
        doit(connectSocket);
        exit(0);
    }
    close(connectSocket);
}
```

When a connection request is received and accepted, the process forks, with the child process servicing the connection and the parent process waiting for another connection request. The connectSocket descriptor returned by accept( ) refers to a complete TCP association, a ‘connection,’ a data structure housing the complete network addresses and port numbers for both client and server for this connection. On the other hand, the listenSocket argument that is passed to accept( ) only has the network address and the port number for the server process. The client network address and client port number are unknown at that point and remain so until accept( ) returns. This allows the original process, the parent, to accept( ) another connection using listenSocket without having to create another socket descriptor. This server, like most connection—oriented servers, is a concurrent processors, and so creates a new socket (‘connectSocket’) automatically as part of the accept( ) system call. In a TCP system, connectSocket is typically the socket representing the next connection request on the connection backlog queue. In this way, the system continues to use the same socket for all listening on the port (‘listenSocket’), while using sockets from the connection backlog queue as connections for server processing.

Accept processing time is the time interval between calls to accept( ). If there is no connected socket ready on the connection backlog queue, accept( ) blocks and waits for one. If fork( ) and close( ) processing are fast, therefore, the accept processing rate is the request rate. Fork( ) and close( ) however, are CPU-bound system calls. If fork( ) and close( ) processing are slow enough to reduce the accept processing rate below the request rate, the connection backlog queue load will increase. The method of FIG. 10, therefore advantageously includes comparing (954) the accept processing time and the arrival interval (the inverse of the request rate). If the accept processing time is larger (956) than the arrival interval, the method of FIG. 10 includes increasing (958) the connection backlog queue size.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for dynamically provisioning computer system resources, the method comprising:
monitoring a connection performance parameter of a data communications port operating in a data communications protocol having a connection backlog queue having a connection backlog queue size; and
changing the connection backlog queue size in dependence upon the monitored connection performance parameter without interrupting the operation of the data communications port and without user intervention.

2. The method of claim 1 wherein:
monitoring a connection performance parameter further comprises receiving a connection request and determining that the connection backlog queue is full; and
changing the connection backlog queue size in dependence upon the monitored connection performance parameter further comprises increasing the connection backlog queue size.

3. The method of claim 1 wherein:
monitoring a connection performance parameter further comprises monitoring a connection backlog queue load; and
changing the connection backlog queue size further comprises changing the backlog queue size in dependence upon the connection backlog queue load.

4. The method of claim 1 wherein:
monitoring a connection performance parameter further comprises calculating an average round trip time for a portion of a connection handshake and calculating an average arrival interval between connection requests; and
changing the connection backlog queue size further comprises increasing the connection backlog queue size if the average arrival interval is less than the average round trip time and decreasing the connection backlog queue size if the average arrival interval is greater than the average round trip time.

5. The method of claim 1 wherein:
monitoring a connection performance parameter further comprises calculating a bandwidth delay product for a connection backlog queue and comparing the bandwidth delay product with the queue size; and
changing the connection backlog queue size further comprises changing the backlog queue size to at least the bandwidth delay product if the connection backlog queue size is less than the bandwidth delay product.

6. The method of claim 1 wherein:
monitoring a connection performance parameter further comprises measuring accept processing time; and
changing the connection backlog queue size further comprises changing the backlog queue size in dependence upon accept processing time.

7. The method of claim 1 wherein:
monitoring a connection performance parameter further comprises calculating an average accept processing time and calculating an average connection request arrival interval for a connection backlog queue; and
changing the connection backlog queue size further comprises increasing the connection backlog queue size if the accept processing time is greater than the connection request arrival interval.

8. A system for dynamically provisioning computer system resources, the system comprising:
means for monitoring a connection performance parameter of a data communications port operating in a data communications protocol having a connection backlog queue having a connection backlog queue size; and
means for changing the connection backlog queue size in dependence upon the monitored connection performance parameter without interrupting the operation of the data communications port and without user intervention.

9. The system of claim 8 wherein:
means for monitoring a connection performance parameter further comprises means for receiving a connection request and means for determining that the connection backlog queue is full; and
means for changing the connection backlog queue size in dependence upon the monitored connection performance parameter further comprises means for increasing the connection backlog queue size.

10. The system of claim 8 wherein:
means for monitoring a connection performance parameter further comprises means for monitoring a connection backlog queue load; and
means for changing the connection backlog queue size further comprises means for changing the backlog queue size in dependence upon the connection backlog queue load.

11. The system of claim 8 wherein:
means for monitoring a connection performance parameter further comprises means for calculating an average round trip time for a portion of a connection handshake and means for calculating an average arrival interval between connection requests; and
means for changing the connection backlog queue size further comprises means for increasing the connection backlog queue size and means for decreasing the connection backlog queue size.

12. The system of claim 8 wherein:
means for monitoring a connection performance parameter further comprises means for calculating a bandwidth delay product for a connection backlog queue and means for comparing the bandwidth delay product with the queue size; and
means for changing the connection backlog queue size further comprises means for changing the backlog queue size to at least the bandwidth delay product.

13. The system of claim 8 wherein:
means for monitoring a connection performance parameter further comprises means for measuring accept processing time; and
means for changing the connection backlog queue size further comprises means for changing the backlog queue size in dependence upon accept processing time.

14. The system of claim 8 wherein:
means for monitoring a connection performance parameter further comprises means for calculating an average accept processing time and means for calculating an average connection request arrival interval for a connection backlog queue; and
means for changing the connection backlog queue size further comprises means for increasing the connection backlog queue size.

15. A computer program product for dynamically provisioning computer product resources, the computer program product comprising:
a recording medium;
means, recorded on the recording medium, for monitoring a connection performance parameter of a data communications port operating in a data communications protocol having a connection backlog queue having a connection backlog queue size; and
means, recorded on the recording medium, for changing the connection backlog queue size in dependence upon the monitored connection performance parameter without interrupting the operation of the data communications port and without user intervention.

16. The computer program product of claim 15 wherein:
means, recorded on the recording medium, for monitoring a connection performance parameter further comprises means, recorded on the recording medium, for receiving a connection request and means, recorded on the recording medium, for determining that the connection backlog queue is full; and
means, recorded on the recording medium, for changing the connection backlog queue size in dependence upon the monitored connection performance parameter further comprises means, recorded on the recording medium, for increasing the connection backlog queue size.

17. The computer program product of claim 15 wherein:
means, recorded on the recording medium, for monitoring a connection performance parameter further comprises means, recorded on the recording medium, for monitoring a connection backlog queue load; and
means, recorded on the recording medium, for changing the connection backlog queue size further comprises means, recorded on the recording medium, for changing the backlog queue size in dependence upon the connection backlog queue load.

18. The computer program product of claim 15 wherein:
means, recorded on the recording medium, for monitoring a connection performance parameter further comprises:
means, recorded on the recording medium, for calculating an average round trip time for a portion of a connection handshake; and
means, recorded on the recording medium, for calculating an average arrival interval between connection requests; and
means, recorded on the recording medium, for changing the connection backlog queue size further comprises:
means, recorded on the recording medium, for increasing the connection backlog queue size; and
means, recorded on the recording medium, for decreasing the connection backlog queue size.

19. The computer program product of claim 15 wherein:
means, recorded on the recording medium, for monitoring a connection performance parameter further comprises means, recorded on the recording medium, for calculating a bandwidth delay product for a connection backlog queue and means, recorded on the recording medium, for comparing the bandwidth delay product with the queue size; and
means, recorded on the recording medium, for changing the connection backlog queue size further comprises means, recorded on the recording medium, for changing the backlog queue size to at least the bandwidth delay product.

20. The computer program product of claim 15 wherein:
means, recorded on the recording medium, for monitoring a connection performance parameter further comprises means, recorded on the recording medium, for measuring accept processing time; and
means, recorded on the recording medium, for changing the connection backlog queue size further comprises means, recorded on the recording medium, for changing the backlog queue size in dependence upon accept processing time.

21. The computer program product of claim 15 wherein:
means, recorded on the recording medium, for monitoring a connection performance parameter further comprises means, recorded on the recording medium, for calculating an average accept processing time and means, recorded on the recording medium, for calculating an average connection request arrival interval for a connection backlog queue; and
means, recorded on the recording medium, for changing the connection backlog queue size further comprises means, recorded on the recording medium, for increasing the connection backlog queue size.
